(19) United States
(12) Patent Application Publication
(10) Pub. No.: US 2010/0070871 A1
(43) Pub. Date: Mar. 18, 2010

(54) Extendable Recommender Framework for Web-Based Systems

(75) Inventors: Stefan Liesche, Boeblingen (DE); Andreas Nauerz, Boeblingen (DE); Martin Welsch, Herrenberg (DE)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/209,808

(22) Filed: Sep. 12, 2008

(51) Int. Cl. G06F 3/048

(52) U.S. Cl. 715/744

(57) ABSTRACT

A method for extending a portal by a recommender framework that involves providing a portal having a plurality of recommendation engines plugged into the portal via interfaces. Portal users' interaction behavior data are passed to the plurality of recommendation engines, and recommendations are retrieved from the recommendation engines via the recommendation manager. Recommendations for a user are correlated to a context in which the user is currently acting by a context manager, and recommendations for the user are calculated by the recommendation engines based on the users' interaction behavior data received by the recommendation engines via the recommendation manager and merged transparently to the user based on pre-determined weightings assigned to each of the plurality of recommendation engines. A recommendation to be presented to the user is determined based on the user's interests and preferences identified according to pre-defined user and context models.

### CROSS-REFERENCE TO RELATED APPLICATION

This application is related to commonly assigned application Attorney Docket No. DE9 2008 0171 entitled “METHOD FOR GRAPHICAL VISUALIZATION OF MULTIPLE TRAVERSED BREADCRUMBS TRAILS”; Attorney Docket No. DE9 2008 0172 entitled “METHOD FOR AUTOMATICALLY CONSTRUCTING PAGEFLOWS BY ANALYZING TRAVERSED BREADCRUMBS”; and Attorney Docket No. DE9 2008 0173 entitled “METHOD FOR AUTOMATICALLY CONSTRUCTING MEGAFLOWS AND SUPERFLOWS BY ANALYZING TRIVERSED BREADCRUMBS OF INTIRE COMMUNITIES”, each filed simultaneously herewith and each of which is incorporated herein by this reference.

### BACKGROUND OF THE INVENTION

1. Field of the Invention

This invention relates to web portals and more particularly to a method for extending a portal by an open, pluggable recommender framework that allows transparent integration of different recommender engines into a portal.

2. Description of Background

FIG. 1 is a schematic system view of an example of a portal server implementing an existing art portal. A prior art portal such as WebSphere™ portal by IBM™ is built by a complex functionality implemented on a network server, such as application server 100 illustrated in FIG. 1. The most important elements of such server are logic components for user authentication 105, state handling 110, aggregation of fragments 115, a plurality of portlets 120 provided in respective pages 125 with a respective plurality of APIs 130 to a respective portlet container software 135 for setting the portlets 120 into the common page context, and portal storage resources 140. The logic components are operatively connected such that data can be exchanged between single components as required as represented in FIG. 1.

The existing art portal realizes a request/response communication pattern, i.e., it waits for client requests and responds to those requests. A client request message includes a URL/URI which addresses the requested portal page and/or other portal resources.

More specifically, an existing art portal such as illustrated in FIG. 1 implements an aggregation of portlets 120 based on the underlying portal model 150 comprising a hierarchy of portal pages that may include portlets and portal information such as security settings, user roles, customization settings, and device capabilities. Within the rendered page, the portal automatically generates the appropriate set of navigation elements based on the portal model. The portal engine invokes portlets during the aggregation as required and when required and uses caching to reduce the number of requests made to portlets. The existing art WebSphere™ portal by IBM™ employs open standards such as the Java™ portlet application programming interface (API). It also supports the use of a remote portlet via the Web Service for Remote Portlets (WSRP) standard.

Referring again to FIG. 1, the portlet container 135 is a single control component competent for all portlets 120, which may control the execution of code residing in each of these portlets. It provides the runtime environment for the portlets and facilities for event handling, inter-portlet messaging, and access to portlet instance and configuration data, among others. The portal resources 140 are in particular the portlets 120 themselves and the pages 125 on which they are aggregated in the form of an aggregation of fragments and the navigation model. A portal database 128 stores the portlet description, which details the portlet description featuring attributes such as portlet name, portlet description, portlet title, portlet short title, and keywords. The portal database 128 also stores the content model 150 which defines the portal content structure, i.e., the structure of pages and comprises page definitions. A page definition describes a portal page and references the components (e.g. portlets) that are contained in the page. This data is stored in the database 128 in an adequate representation based on existing art techniques such as relational tables.

Referring further to FIG. 1, some existing art portals contain a navigation component 165 which provides the possibility to nest elements and to create a navigation hierarchy, which is stored in the portal model.

Referring once more to FIG. 1, an important activity in existing art rendering and aggregation 115 processes is the generation of URLs that address portal resources, e.g., pages 125. A URL is generated by the aggregation logic and includes coded state information. The aggregation state as well as the portlet state is managed by the portal. The aggregation state can include information such as the current selection including the path to the selected page in the portal model, the portlets modes and states, the portlet render and action parameters, etc. By including the aggregation state in a URL, the portal ensures that it is later able to establish the navigation and presentation context when the client sends a request for the particular URL. A portlet can request the creation of a URL through the portlet API and provide parameters, i.e., the portlet render and action parameters to be included in the URL.

Referring again to FIG. 1, the user repository 129 contains user information and authentication information for each portal user. The user repository may be implemented in a database or a prior art Lightweight Directory Access Protocol (LDAP) directory. The user repository 129 supports various retrieval operations to query information about one user, multiple users or all portal users.

FIG. 2 is a diagram that illustrates an example of existing art interactions in a portal during render request processing. Referring to FIG. 2, a client 220 is depicted at the left side of the diagram with the portlet markup A, B, and C of respective portlets in the client browser. The portal container 135 in the central portion of the diagram and the diverse portlets A, B, and C are depicted at the right side of the diagram. The communication is based on requests which are expressed in the depicted arrows.

Referring further to FIG. 2, in particular, the client 220 issues a render request 260, e.g., for a new page, by clicking on a link displayed in its browser window. The link contains a URL, and in reaction to the user action, the client 22o issues the render request 260 containing the URL. To render the new page, the portal 135 (after receiving the render request 260) invokes state handling, passing the URL. State handling then determines the aggregation state and the portlet state that is encoded in the URL or that is associated with the URL. Typically, the aggregation state contains an identification of the requested page. Aggregation 115 checks if a derived page exists for this user. Aggregation 115 loads the according page definition from the portal database 128 and determines the portlets that are referenced in the page definition, i.e., that are contained on the page. Aggregation 115 sends an own render request 270 to each portlet through the portlet container 135. In the existing art, each portlet A, B and C creates its own markup independently and returns the markup fragment with the respective request response 280. The portal aggregates the markup fragments and returns the new page to the client 220 in a respective response 290.

Referring back to FIG. 1, a graphical user interface component 160 is provided for manually controlling the layout of the plurality of rendered pages. By that interface 160, a portal administrator or user is enabled to control the visual appearance of the portal pages (e.g., by creating new pages and/or by adding or removing portlets on pages). In particular, the administrator or user can decide which portlet is included at a given portal web page by adding portlets to pages or by removing portlets from pages. The manual layout interface 160 invokes the model management 161 which comprises the functionality for performing persistent content model changes and offers an API for invoking this functionality.

Some existing art portals support the concept of page derivation. This concept allows for a stepwise specialization of a page. In the first step, an administrator A creates a page, defines a base layout, and adds content (i.e., portlets) to the page. Thereafter, the administrator grants appropriate rights to other administrators or users, who themselves can derive the page and edit the layout and content of a page, but not any locked elements. When an administrator or a user modifies the page, model management 161 creates a derivation of the page and stores it into the portal database 128. It also stores an association between the implicit derivation and the user that performed the page modification.

For example, assume administrator A creates a page X that comprises portlet A, and administrator B adds portlet B to page X, which results in the creation of the derived page X′. Assume further that user C is authorized to view the page X (and thus X′). In this case, when issuing a request for page X, administrator A will see portlet A (corresponding to page X), administrator B will see Portlet A and B (corresponding to page X′), and user C will also see portlets A and B (corresponding to page X′). Aggregation 115 automatically selects the according page during request processing based on the aggregation state and the ID of the user issuing the request. Now, assume user C modifies the page to include portlet C. The portal thus creates a new derived page X″ and stores it into the database 128. The derived page is associated with user C. When now invoking a request for page X, administrator A will see portlet A, administrator B will see Portlet A and B (corresponding to page X′), and user C will see portlets A, B and C (corresponding to page X″).

Information overload has been a well known problem for quite some time. Portal systems were initially devised to fight this phenomenon. Such portal systems focused on presenting the most valuable and widely used information to users, providing them with quick and efficient information access. This worked fine as long as the amount of information available was moderate and information was entered by a relatively small group of administrators in a well planned and structured way. However, both conditions are no longer fulfilled. Nowadays, the amount of available and possibly relevant information grows exponentially. To make matters worse, this information is no longer entered into the portal in a carefully orchestrated way. Rather, with the advent of Web 2.0 (e.g., emphasis on enhancing information sharing and collaboration among users), user generated content rapidly gains importance. Thus, to fight information overload for the users of today's portals, new mechanisms are needed.

One such mechanism is known as a recommender system. Recommender systems are components that recommend content or people to the user in which the user might be interested but of which the user is unaware. Today, numerous recommender systems are available that use different techniques to determine what might be relevant. However, each of them works best for a specific class of applications. Portal solutions can be used in a wide range of application fields. It is thus not possible to decide on one of the existing recommender systems and integrate it into the portal solution. In this case, only some of the applications for which the portal is used will be adequately supported.

Recommender systems form a specific type of information filtering technique that attempts to present information items, such as movies, music, books, news, images, web pages, that are likely of interest to the user. Typically, a recommender system compares the user's profile to some reference characteristics. These characteristics may be from the information item (i.e., a content-based approach) or the user's social environment (i.e., a collaborative filtering approach).

Information on how to build the data model which forms a basis for calculating recommendations can be retrieved via many ways. Examples of explicit data collection include asking a user to rate an item on a sliding scale, asking a user to rank a collection of items from favorite to least favorite, presenting two items to a user and asking him/her to choose the best one, and asking a user to create a list of items that he/she likes. Examples of implicit data collection include observing the items that a user views in an online store, analyzing item/user viewing times, keeping a record of the items that a user purchases online, obtaining a list of items to which a user has listened or watched on his/her computer, and analyzing the user's social network and discovering similar likes and dislikes.

The recommender system compares the collected data to similar data collected from others and calculates a list of recommended items for the user. One of the most commonly used algorithms in recommender systems is the Nearest Neighborhood approach. In a social network, a particular user's neighborhood with similar tastes or interests can be found by calculating the Pearson product-moment correlation coefficient (Pearson's correlation). By collecting the preference data of the top-N nearest neighbors of the particular user, the user's preference can be predicted by calculating the data using certain techniques.

In portal systems many content entities can be recommended. In non-ColdFusion™ (non-CF) scenarios, users can be analyzed separately, not taking into account what other users did. For example, an analysis can be made of how people navigate through information spaces by clicking pages or by which portlets he/she uses most often. A utilization model can be calculated that allows a recommendation of favorite content to be made or access to short-cuts to be given (e.g. when navigating). This way, users can get access to favorite content and short-cuts. In the CF scenario, an analysis can be made for a single user what might be of interest for him/her based on what other users found to be interesting that recently behaved similarly. In this way, users can get access to content that is of interest but which he/she never came across.

A problem is that currently there are many different kinds of content entities that are reasonable to be recommended to a user. Depending on their portal deployment and their business, companies typically have totally different matters that they would like to have recommended. For example, insurance companies might want to recommend insurance of type A to customers who recently bought insurance of type B. Other companies might want to recommend documents because they have a document-centric portal. Still other companies might want to recommend blog and wiki entries because they have collaborative portals and others might simply want to recommend particular products, such as foods or publications.

The question is how can portals make it easy for customers to feed a recommendation engine and retrieve recommendations without the need to learn about the underlying techniques (i.e., without the need to feed a database explicitly, to record and analyze the transactions, and to calculate, retrieve, and display recommendations, etc.).

### SUMMARY OF THE INVENTION

The shortcomings of the prior art are overcome and additional advantages are provided through embodiments of the invention that propose a method for extending a portal by a recommender framework that involves, for example, providing a portal having a plurality of recommendation engines plugged into the portal via interfaces, and recording portal users' interaction behavior data via intercepting data regarding events which are stored in a transaction database accessible by a recommendation manager for the recommendation engines. Portal users' interaction behavior data are passed to the plurality of recommendation engines, and recommendations are retrieved from the recommendation engines via the recommendation manager.

Embodiments of the invention further propose determining to which of the plurality of recommendation engines to pass which interaction behavior data and from which of the plurality of recommendation engines to retrieve recommendations when needed by an engine selector. Recommendations for a user are correlated to a context in which the user is currently acting by a context manager, and recommendations for the user are calculated by the recommendation engines based on the users' interaction behavior data received by the recommendation engines via the recommendation manager and merged transparently to the user based on pre-determined weightings assigned to each of the plurality of recommendation engines. A recommendation to be presented to the user is determined based on the user's interests and preferences identified according to pre-defined user and context models.

### TECHNICAL EFFECTS

As a result of the summarized invention, technically we have achieved a solution for implementing a method for extending a portal by an open, pluggable recommender framework which allows different recommender engines to be plugged-into the portal transparently to a user.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic system view of an example of a portal server implementing an existing art portal;

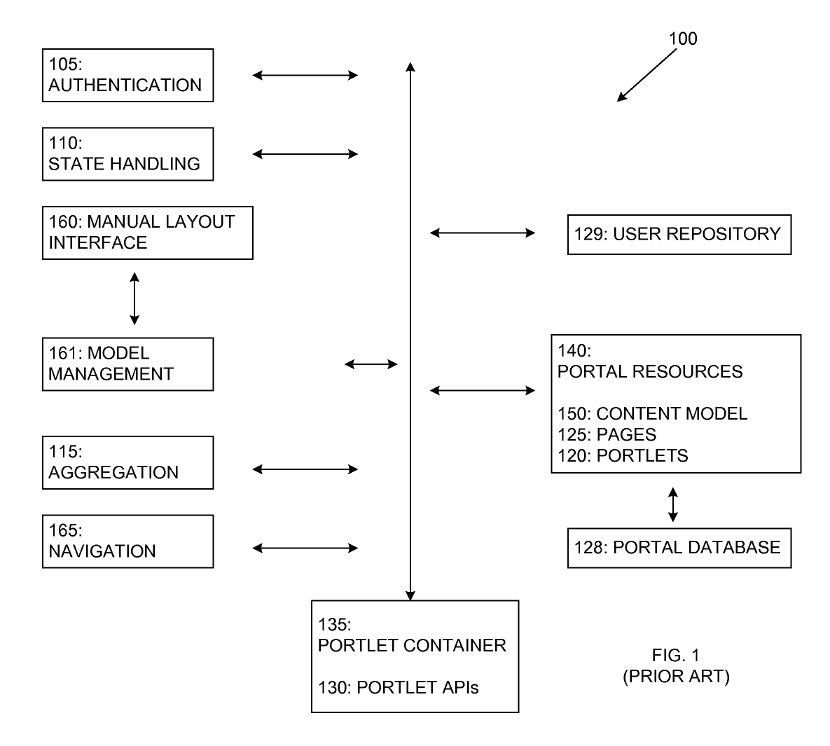

FIG. 2 is a diagram that illustrates an example of existing art interactions in a portal during render request processing;

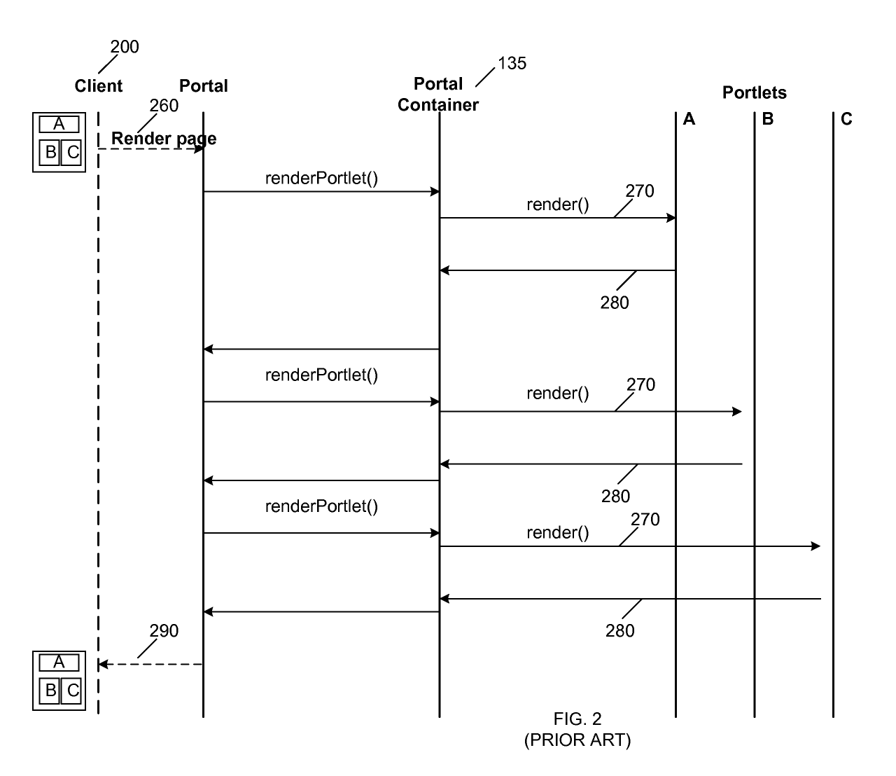

FIG. 3a is a schematic system view of an example of a portal server for embodiments of the invention;

FIG. 3b is a schematic system view of an example of a recommender framework for embodiments of the invention; and

FIG. 3c is a diagram that illustrates an example of possible recommendations for users for embodiments of the invention.

The detailed description explains the preferred embodiments of the invention, together with advantages and features, by way of example with reference to the drawings.

### DETAILED DESCRIPTION OF THE INVENTION

A main focus of embodiments of the invention is extending a portal by an open, pluggable recommender framework which allows different recommender engines to be plugged-into the portal. Recommender engines can recommend content, items, etc. based on the various techniques, some of which are described in the “Background of the Invention” herein.

Embodiments of the invention propose a generic recommender framework that allows transparently integrating different recommender engines into a portal. The framework comes with a number of pre-installed recommender engines and can be extended by adding further such components. Recommendations are computed by each engine and then transparently merged. This ensures that neither the portal vendor, the portal operator, nor the portal user is burdened with choosing an appropriate engine, while nevertheless enabling high quality recommendations to be made.

The framework for embodiments of the invention is responsible for feeding each recommender engine with data which forms the basis for calculating the actual recommendations. Each recommender engine can decide on its own whether to store the data being received in case it is of interest for calculating its recommendations or to neglect the data. Typical data being transmitted includes users' interaction behavior, such as clicks on pages, portlets, or more generally, content entities.

In addition, the framework for embodiments of the invention is responsible for fetching and merging the single recommendations being provided by the single recommender engines that have been plugged in. Therefore, the framework for embodiments of the invention asks every single engine for its recommendations and merges the recommendations into a list of the top “n” recommendations. Such merging can be based, for example, on weightings that have been assigned to the single engines.

PortalServices and PortletServices (interfaces) allow portal vendors to extend their own components with recommendation capabilities. They can leverage these services from within the portal's theme or from within portlets to feed interaction data to the recommender framework and to receive recommendations from it. Thus, these services hide the complexity of the underlying recommendation technology entirely.

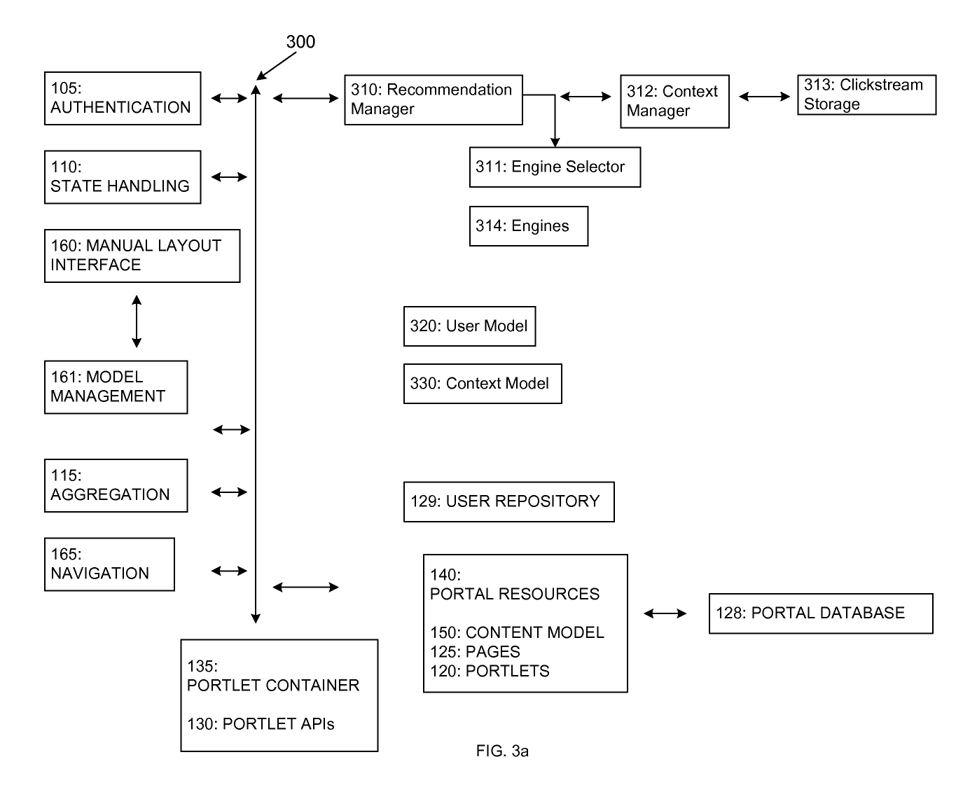

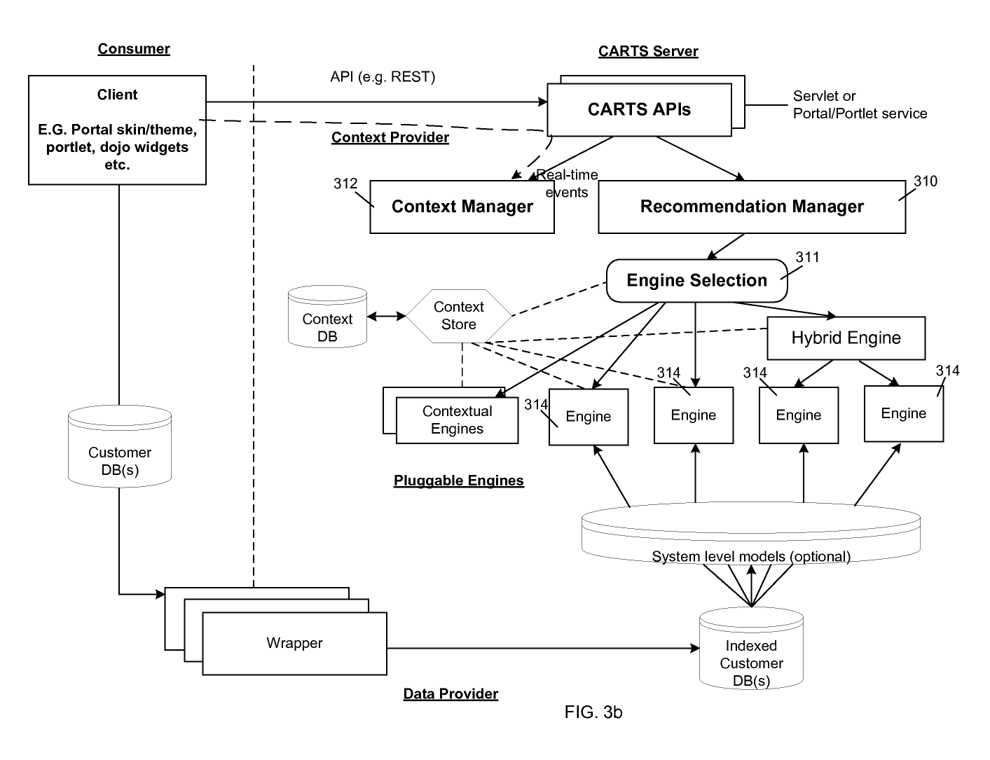

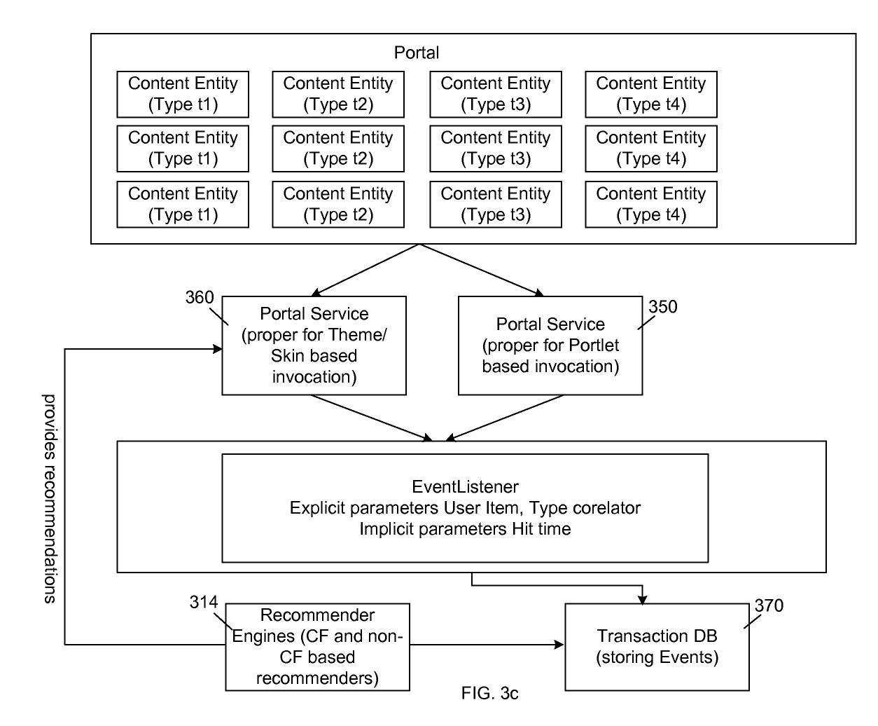

FIG. 3a is a schematic system view of an example of a portal server for embodiments of the invention. FIG. 3b is a schematic system view of an example of a recommender framework for embodiments of the invention. Referring to FIGS. 3a and 3b, the portal 300 is extended by a recommendation manager 310 which passes transactional data to the actual recommendation engines 314. In addition, a context manager 312 correlates recommendations to the context in which a user is acting. The engine selector 311 determines to which engine to pass which transactional data and from which engine to retrieve recommendations when needed. The actual engines 314 are responsible for calculating actual recommendations based on the transactional data that have previously been handed over to them. User and context models 320, 330 describe users' interests and preferences, especially in a certain context. This information is used to determine the recommendations to be presented to a user.

FIG. 3c is a diagram that illustrates an example of possible recommendations for users for embodiments of the invention. Referring to FIGS. 3a, 3b, and 3c, specifically for portals, portlets communicate via PortletServices 350 or PortalServices 360 to pass data via the recommendation manager 310 to the engines 314 and to retrieve recommendations from them. Different content entities can be distinguished as such, so that portlets 120 can ask for recommendations of a certain type (e.g. documents) easily. Users' transaction behavior is recorded via intercepting events which are stored in a transaction database 370 and used by some of the initial recommenders previously described.

According to embodiments of the invention, users interact with the portal 300 as usual. When doing so, they often interact with content entities of certain types, such as documents, blog entries, wiki entries, products, and the like. These entities are presented in the portal's theme, in portlets or elsewhere. Businesses seek means for allowing them to recommend a subset of these entities to their users leveraging recommender technologies, such as CF. Embodiments of the invention provides customers with an extensible framework by which businesses can associate content entities to the invocation of a special portal/portlet service. By doing this, they can record transactions, such as a user opening and/or deleting a document, which form the basis for the recommender's data model.

Such transactions give insights about which user interacted with which item which was of a certain type (correlator). Embodiments of the invention wrap a portal's event trigger/listener (i.e., part of an event broker framework). The transactions are thus stored in the recommender's database. Pluggable recommender engines 314 analyze the transactions and calculate recommendations which businesses can retrieve according to the framework for embodiments of the invention. The recommendations can then be displayed as part of the portal's theme/portlet etc. Thus, businesses can easily recommend content entities without knowing about the underlying details of the recommendation technology simply by firing events that occurred when users interacted with certain items. Correlators allow storage/retrieval of recommendations of certain types only.

The framework for embodiments of the invention additionally proposes a set of initial recommender engines that automatically provides recommendations to background information and related content either by displaying shortcuts to relevant pages or by showing portlets containing links to relevant information. These engines come in two flavors, namely, recommender engines based on the user model and collaborative filtering recommenders. Further, both types of recommender engines can leverage the context model in order to provide recommendations with respect to a particular situation in which the user is currently working.

The first category of initial recommender engines provide recommendations to related content based on the information stored in the user model which reflects static information about the user, such as language preferences, age, location, etc., as well as navigation behavior of individual users, including their favorite pages and routes through the entire navigation topology of the portal. Accessing certain properties of the user model, the navigation topology is automatically changed in order to reveal the interesting pages and hide irrelevant content.

To identify which parts of the navigation topology could be recommended to a user, the utilization of each single page is calculated. As used herein, every time the user accesses a page it is said that the page receives a “hit”, and every time the user actually interacts with a page to perform a task or to receive some information, it is said that the page receives a “target hit”. Interesting metrics to calculate the utilization include, for example, the number of times the user invokes a page, the number of times a user interacts with a page, the frequency of visits, and the time or duration that the user interacts with a page

The framework for embodiments of the invention employs structure reordering algorithm to rearrange pages that are part of the navigation topology. The user model contains information about the utilization of single pages and hence of their importance to individual users. Each level in the navigation tree is assigned a utilization threshold that all the pages lying in that level have to exceed. During the structure adaptation, each page is moved to the highest possible level (i.e., as close as possible to the root) having a utilization threshold lower than or equal to its utilization.

During the adaptation, the algorithm can perform three different operations. A promotion is performed if a page has a utilization greater than the next higher level's threshold and the page is recursively promoted to the highest possible level. Similar nodes are demoted or even hidden if not used at all. Continuous adaptation based on the most current user models available guarantees that the navigation topology permanently fits the user's needs as best as possible. As soon as a user's behavior changes, the user model also changes and hence the navigation topology provided.

Alternatively, automatic provisioning of recommendations avoids the permanent restructuring of the navigation topology while still providing users with the advantages of this feature. Here, recommendations can be blended into the portal's theme that provide users with reasonable shortcuts to pages as part of the topology.

An idea behind embodiments of the invention is to provide the user with an adaptive navigational aid aside from the static navigation menu by blending in a set of reasonable shortcuts which reduces the effort to be spent when navigating through usual paths. These shortcuts are dynamically generated depending on the current navigational position. In order to predict shortcuts to nodes that are far away from the current node but have a high probability to be navigated to, a minpath algorithm is utilized. The algorithm takes into account both the probability that a link is followed and the amount of navigation clicks saved in order to calculate the so-called expected savings. Values for expected savings are calculated for each possible destination page as the product of the probability that the user navigates to that page and the number of clicks saved by the shortcut.

In contrast to the recommenders that provide recommendations based on the analysis of the navigation history of only one particular user, the collaborative filtering recommenders for embodiments of the invention provide links to background information and related content based on the analysis of the navigation behavior of multiple users. The collaborative filtering engines first try to identify the users that have similar tastes and navigation behavior with the current user and then retrieve the items that these users liked most and recommend them to the current user. The CF-based recommendations help to discover new and unknown content items that might be of interest for a particular user.

Thus far, only recommendations based on the navigation history of individual users and commonalities of interests among multiple users without respect to the context in which the users are acting have been described. However, in embodiments of the invention, the initial recommenders of both categories can also access the context model in order to provide recommendations that could be especially relevant in certain situations. The recommendation framework for embodiments of the invention allows single users to have several context profiles. These profiles can be recommended to the user automatically by the system for embodiments of the invention, or users can switch between them manually.

According to embodiments of the invention, new profiles can be defined using a profile management portlet which allows specifying the settings of a profile (e.g., which theme to use, which skin to use, which navigation topology to display etc.) and to associate it with a set of context attributes which define when it should become active. Whatever people do only influences the models associated to the currently active profile. If the currently active profile, for example, is \textit{business}, all the navigation behavior, all the usage behavior of portal pages etc. affects only the models associated to the particular profile but never influences the models associated to the \textit{private} profile.

For a determination of the best matching profile, embodiments of the invention permanently observe a set of defined context attributes. Users always have the option to outvote a decision of embodiments of the invention and to manually switch to another profile. A learning mode allows users to let the system learn about their needs and tastes in a specific new context.

The flow diagrams depicted herein are only examples. There may be many variations to these diagrams or the steps (or operations) described therein without departing from the spirit of the invention. For example, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method for extending a portal by a recommender framework, comprising:
providing the portal having a plurality of user model recommendation engines and a plurality of collaborative filtering recommendation engines plugged into the portal via interfaces;
recording interaction behavior data for a particular user of the portal and for a plurality of other users of the portal via intercepting data regarding events which are stored in a transaction database accessible by a recommendation manager for use respectively by the plurality of user model recommendation engines and the plurality of collaborative filtering recommendation engines;
wherein the interaction behavior data for the particular user of the portal regarding events stored for use by the plurality of user model recommendation engines further comprises utilization of each of a plurality of pages of the portal by the particular user of the portal based on metrics consisting at least in part of a number of times each page of the portal was invoked by the particular user of the portal, a number of times the particular user of the portal interacted with each page of the portal, a duration of time that the particular user of the portal interacted with each the page of the portal, and a frequency of visits to each page of the portal by the particular user of the portal;
passing interaction behavior data for the particular user of the portal and for the plurality of other users of the portal respectively to the plurality of user model recommendation engines and the plurality of collaborative filtering recommendation engines and retrieving recommendations for the particular user of the portal respectively from the plurality of user model recommendation engines and the plurality of collaborative filtering recommendation engines via the recommendation manager;
determining to which of the respective pluralities of user model and collaborative filtering recommendation engines to pass which interaction behavior data and from which of the respective pluralities of user model and collaborative filtering recommendation engines to retrieve the recommendations when needed by an engine selector;
correlating the recommendations for the particular user of the portal to a context in which the particular user of the portal is currently acting by a context manager;
calculating the recommendations for the particular user of the portal by the pluralities of user model and collaborative filtering recommendation engines based respectively on the interaction behavior data for the particular user of the portal and for the plurality of other users of the portal received by the plurality of user model recommendation engines and the plurality of collaborative filtering recommendation engines via the recommendation manager;
merging the respective calculated recommendations transparently to the particular user of the portal based on pre-determined weightings assigned to each of the pluralities of user model and collaborative filtering recommendation engines; and
determining at least one of the recommendations to be presented to the particular user of the portal based on the interests and preferences of the particular user of the portal identified according to pre-defined user and context models.
